(19) United States
(12) Patent Application Publication
(10) Pub. No.: US 2026/0203329 A1
(43) Pub. Date: Jul. 16, 2026

(54) CONVERSATIONAL COMPOSITE ACTION EXECUTION

(71) Applicant: o9 Solutions, Inc., Dallas, TX (US)

(72) Inventors: Rajeev Karri, Bangalore (IN); Srinath Goud Vanga, San Jose, CA (US); Koustuv Chatterjee, Gilbert, AZ (US)

(21) Appl. No.: 19/561,121

(22) Filed: Mar. 9, 2026

Related U.S. Application Data
(63) Continuation of application No. 18/824,611, filed on Sep. 4, 2024, now abandoned.
(60) Provisional application No. 63/605,108, filed on Dec. 1, 2023.

(30) Foreign Application Priority Data
Sep. 4, 2023 (IN) 202311059231

(51) Int. Cl. G06F 16/334; G06F 16/901; G06F 21/62; G06F 40/30; G06T 11/26

(52) U.S. Cl. CPC G06F 16/3344; G06F 16/3347; G06F 16/9024; G06F 21/62; G06F 40/30; G06T 11/26; G06F 2221/2141

(57) ABSTRACT

Systems and techniques for conversational composite action execution are described herein. Natural language workflow descriptions are received from expert users, the descriptions are processed using language models to identify action sequences, and directed acyclic graphs (DAGs) are generated that represent workflows by mapping actions to automated agents. These DAGs are stored as composite action recipes in a vector database. End users can then submit natural language queries, which the system matches to stored recipes. Selected recipes are executed in a sandboxed environment, with the system sequentially invoking automated agents according to the DAG structure. The systems and techniques described herein provide real-time feedback during execution and support features such as graphical workflow validation, dynamic parameter collection, role-based access control, and dry run simulations. This approach enables efficient creation and reuse of complex workflows based on natural language inputs.

### CLAIM OF PRIORITY

This patent application is a continuation of U.S. patent application Ser. No. 18/824,611, filed Sep. 4, 2024, which application claims the benefit of U.S. Provisional Patent Application No. 63/605,108, filed Dec. 1, 2023, and claims the benefit of India Patent Application No. 202311059231, filed Sep. 4, 2023, which are incorporated by reference herein in their entireties.

### TECHNICAL FIELD

Embodiments described herein generally relate to natural language-based command processing and, in some embodiments, more specifically to reduction of data errors in data update execution based on natural language commands.

### BACKGROUND

Commands issued in natural language may be converted into application specific commands to perform computing operations. There may be errors in the natural language processing or command conversion that result in the presence of errors in the electronic data. Users may wish to provide natural language commands while minimizing data errors.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for conversational composite action execution, according to an embodiment.

FIG. 2 is a flowchart for an example workflow creation process for conversational composite action execution, according to an embodiment.

FIG. 3 is a flowchart of an example of recipe execution process for conversational composite action execution, according to an embodiment.

FIG. 4 illustrates an example agent interaction flow for conversational composite action execution, according to an embodiment.

FIG. 5 illustrate an example data flow for conversational composite action execution, according to an embodiment.

FIG. 6 is a block diagram of an example access control layer for conversational composite action execution, according to an embodiment.

FIG. 7 illustrates an example of data flow of a control flow creation service for conversational composite action execution, according to an embodiment.

FIG. 8 illustrates an example of a method for conversational composite action execution, according to an embodiment.

FIG. 9 is a flowchart of an example of a method for generating and executing composite actions using natural language processing, according to an embodiment.

FIG. 10 is a block diagram illustrating an example of a machine upon which one or more embodiments may be implemented.

### DETAILED DESCRIPTION

The systems and techniques discussed herein convert a natural language description of a workflow provided by an expert user into a program that may be reused later by other common users.

Different user interfaces and functions are provided based on a persona of the user. For example, an expert user may be provided with an interface and tools that enable creation of workflows while a common user (e.g., standard end-user, etc.) may be provided with an interface and tools that enable execution of workflows based on intent of a request submitted by the common user.

A common artificial intelligence (AI) service interfaces with the user. Multiple agents are user that may carry out specific tasks. A conversational composite action composer is used to collect action recipes from an expert user. As used herein, a “recipe” is a collection or composite of computing commands or processes used to execute a workflow by the computing device to create a data update result. The recipes are stored in a composite action library to be executed by an execution engine. In addition to the conversational composite action composer user interface used by an expert to define a recipe, a conversational planning user interface is provided to common users for providing natural language inputs that may trigger execution of one or more recipes from the composite action library.

The natural language description provided by an expert user of a given workflow is evaluated using Large Language Models (LLMs) to segment the natural language passage into a series of specific steps or commands to be executed by the computing system to execute an intended data update action. Each such step is converted into a parameterized call to an agent from an agent library. Dependencies between the steps are tracked and evaluated as either serial or parallel, absolute or conditional, yielding a conditional control flow that is systematically describable in a standard programming language (e.g., Python, etc.). The control flow is presented back to the expert user for validation via the user interface as a graphical representation of the control flow. Upon successful validation, this composite action recipe is stored in the composite action library which may be implemented using a variety of data storage technologies.

When a common user interacts with the system via the user conversational planning user interface, a common AI service uses the LLMs to interpret a natural language request submitted by the user to identify a composite recipe to execute. Further interaction with the common user may be initiated at various steps to make sure parameters required by the agents to execute a step are supplied. The execution engine takes the selected recipe and executes it, displaying the results of each step and securing user consent to proceed to the next step of the workflow systematically executing the full workflow as prescribed by the expert user that created the composite recipe.

The execution design is divided into two main phases: (1) recipe Directed Acyclic Graph (DAG) creation and (2) recipe DAG execution. These phases work in tandem to create a seamless experience for both Expert Users and End Users.

### Recipe DAG Creation

Recipe DAG Creation begins when an Expert User provides a list of detailed natural language instructions to create a recipe. The Common AI service takes these instructions and leverages the power of semantic search to identify relevant atomic agents from the atomic agent library. This search is facilitated by embeddings, which allow for nuanced understanding of the agents'capabilities and their potential relevance to the desired workflow.

Once the relevant agents are identified, the Large Language Model (LLM) comes into play. The LLM is presented with a rich context that includes the identified agents, their descriptions, and their input and output specifications, alongside the original user instructions. This comprehensive prompt enables the LLM to generate a DAG representation of the workflow. This DAG includes all required nodes (representing atomic agents) and the corresponding edges that illustrate the flow of information between these agents.

The system then renders this graph in a user-friendly, graphical manner. This visual representation allows the Expert User to review and modify the workflow as needed. The interface provides a high degree of flexibility, allowing users to adjust input bindings for any given agent. They can choose to hard-code certain inputs, bind them to outputs from upstream agents, or designate them to be provided by the End User at runtime. This level of customization enables the creation of dynamic, adaptable workflows that can cater to a wide range of scenarios.

After finalizing the recipe DAG, the Expert User provides a description of the recipe's purpose and functionality. This description, along with sample queries that could trigger the recipe, is embedded and stored in the vector database. This step is crucial for enabling efficient retrieval of the recipe when End Users later attempt to invoke it through natural language queries.

To ensure the recipe functions as intended, the system offers a dry run mode. This mode allows the Expert User to preview the End User's experience, stepping through the workflow without actually modifying any data in the system. This feature is invaluable for identifying any potential issues or areas for improvement before the recipe is made available to End Users.

### Recipe DAG Execution

Moving on to the Recipe DAG Execution phase, the process begins when an End User interacts with the digital assistant (also referred to as the conversational planner user interface) to request the execution of a specific recipe. The Common AI service plays a crucial role here, taking the user's utterance and classifying it into a specific request type-either an atomic agent call or a recipe execution.

This classification process involves searching through both the agent library and the recipe library to find the most relevant examples. Once these examples are identified, the LLM is prompted with these examples as context, along with a detailed task description as the instruction. This approach allows the system to accurately interpret the user's intent and identify the correct recipe to execute.

Once the appropriate recipe is identified, the execution proceeds in a stepwise manner. Each node in the DAG is executed sequentially, with its results stored in an ephemeral store. This temporary storage is accessible to all other nodes within the recipe, allowing for seamless data flow throughout the execution process.

As each node is executed, it may require certain input parameters. The Common AI service manages this process, facilitating the collection of these parameters based on their predefined types. If a parameter is designated as End User-provided, the Common AI service pauses the execution and engages in a dialog with the user to collect the necessary information. This interactive approach ensures that the workflow remains flexible and responsive to the specific needs of each execution instance.

Once all required inputs for a node are collected, the Common AI service initiates the call to the corresponding atomic agent. During execution, an atomic agent may need to ask further clarification questions to the user. In such cases, the agent enters a ‘need_dialog’ state, and the Common AI service facilitates the conversation between the End User and the agent. This continues until the agent reaches a completed state, ensuring that all necessary information is gathered for successful execution.

As the execution progresses, each agent provides visual or textual feedback to keep the user informed about the ongoing process. The system also offers the ability to pause and inspect the outputs of specific steps in more detail, providing transparency and allowing for user intervention if necessary. This visual or textual feedback ensures that the expected outcomes are achieved at each step of the process and counter any potential hallucinations from agents.

### Access Control Layer

In an enterprise setting, most workflows contain reading and updating data as one of the steps. However, each user that is executing a recipe may have different access to different data elements, as the system allows different kinds of users to execute a recipe, access control layers are applied on the fly at the run time. So, if a step of the recipe contains an update to a data element that the user has no access to, the recipe execution errors out and rollbacks other changes within the DAG.

The systems and techniques discussed herein provide a number of technical benefits to computing resource intensive tasks such a generative AI and network mapping and planning. Some of the technical benefits include: Efficient Workflow Creation: By leveraging large language models to process natural language descriptions, the system significantly reduces the time and effort required to create complex workflows. This eliminates the need for manual programming or intricate flowchart designs, allowing expert users to quickly translate their knowledge into executable processes. Optimized Execution: The system generates a directed acyclic graph (DAG) representing the workflow, which enables efficient execution by identifying parallel, serial, absolute, and conditional relationships between actions. This optimization reduces processing time and computational resources required for workflow execution. Reduced Storage Requirements: The use of a vector database for storing composite action recipes allows for efficient semantic search and retrieval. This approach minimizes storage requirements compared to traditional relational databases, as it leverages embeddings to represent complex workflows compactly. Improved Resource Allocation: The sandboxed execution environment ensures that workflows are executed in isolation, preventing unintended interactions with other system processes. This containment reduces the risk of resource conflicts and improves overall system stability. Enhanced Reusability: By storing workflows as composite action recipes, the system promotes reusability, reducing the need to recreate similar workflows repeatedly. This saves time and computational resources in the long run. Adaptive Resource Utilization: The ability to dynamically collect parameters during execution allows for more efficient resource allocation, as only the necessary resources are utilized based on the specific workflow requirements. Reduced Training Costs: The natural language interface for both expert users and end users minimizes the need for extensive training on complex software systems, leading to reduced training costs and faster onboarding of new users. Improved Data Security: The implementation of role-based access control reduces the risk of unauthorized data access, potentially saving resources that would otherwise be spent on addressing security breaches or data leaks. Efficient Testing: The dry run execution feature allows for testing workflows without modifying actual data, saving resources that might be spent on reversing unintended changes in production environments.

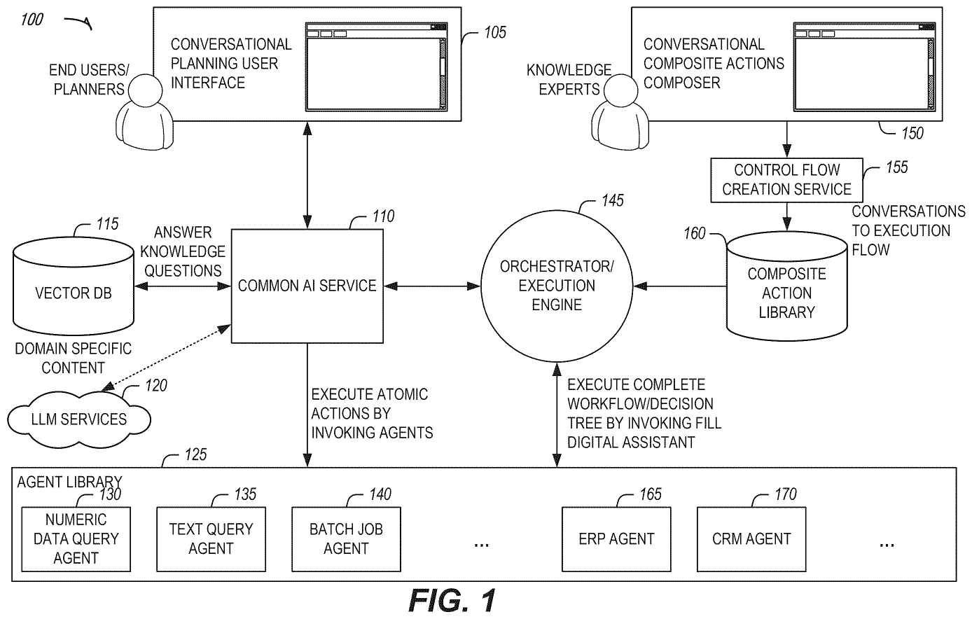

FIG. 1 is a block diagram of an example of a system 100 for conversational composite action execution, according to an embodiment. The system 100 includes a conversational planning user interface 105, a common artificial intelligence (AI) service 110, a vector database 115, a connection to LLM services 120, an agent library 125, an orchestrator 145, a conversational composite actions composer interface 150, a control flow creation service 155, and a composite action library 160. The agent library 125 includes a variety of agents including, by way of example and not limitation, a numeric data query agent 130 for querying numeric data sources, a text query agent 135 for querying textual data sources, a batch job agent 140 for interaction with batch command processing platforms, an enterprise resource planning (ERP) agent for interaction with ERP platforms, and a customer relationship management (CRM) agent for interaction with customer data. The components of the system 100 may be implemented in hardware (e.g., via application specific integrated circuits (ASICs), field programmable gate arrays (FPGAs), etc.) or may be implemented as software instructions stored in non-transitory machine-readable medium that, when executed by at least one processor, perform operations as described herein.

The system 100 utilizes language models to process recipe submissions from expert users via the conversational composite actions composer 150. The recipe provided via the conversational composite actions composer interface 150 is evaluated and segmented into a series of parameterized agent calls for agents in the agent library 125 using metadata provided by the agents. The metadata is stored in the vector database 115 that is used for semantic lookup and matching with the steps of the recipe. The vector database 115 supports semantic searches across the system, storing both atomic agents and recipes using embeddings. This database can return the closest matching results of a specific type (atomic agents or recipes) based on a given search string. It enables efficient retrieval of relevant agents and recipes when processing user queries or constructing workflows.

The agent library 125 may include hundreds of agents and the common AI service 110 is used to narrow down the list to a handful of agents by performing a semantic search using the vector database 115. The agent library 125 contains a collection of specialized agents capable of performing specific tasks within the system 100. These agents are LLM-powered and can be either system-provided or created by third parties. Each agent declares a configuration containing input and output parameters, along with specific schemas. These schemas determine how agents can be connected as upstream or downstream components in a workflow. Agents can be configured to receive input from Expert Users, End Users, or upstream agents. Examples of agents include data reader agents, data update agents, scenario creation agents, and report manager agents. The agent metadata is then provided as a prompt to the LLM services 120 that generates the control flow in conjunction with the control flow creation service 155 representing an executable program of the recipe received via the conversational composite actions composer interface 150. The control flow creation service 155 maps each step to one or more agent calls with their respective parameters.

The common AI service 110 interfaces with users and manages various system 100 functions. It interprets natural language requests from users, identifies appropriate recipes or agents to execute, and oversees workflow execution. This service leverages LLM services 120 to process user inputs and generate responses. It performs semantic searches through the vector database 115 to find relevant agents or recipes based on user queries. During workflow execution, the common AI service 110 facilitates collection of required parameters from users and manages step-by-step execution of recipes.

The LLM services 120 include transformer-based language models (e.g. OPENAI GPT-4, CLAUDE, etc.) for natural language processing and workflow generation. These models are capable of following instructions and calling tools. They are provided with prompts containing instructions and relevant contextual information. The LLM services 120 interpret user inputs, break down expert user instructions into executable steps, and generate control flows for recipes.

The expert user is presented with the generated control flow for final review and feedback via the conversational composite actions composer interface 150. The conversational composite actions composer interface 150 interface allows expert users to create and modify workflows. It provides tools for inputting natural language descriptions of workflows, reviewing generated control flows, and customizing workflow execution parameters. The expert user provides a detailed description of the recipe and when the recipe is finalized with executable control flow, it is registered into the composite action library 160 that is supported by the vector database 115 for semantic search. The conversational composite actions composer interface 150 facilitates creation of workflows by the expert users. It provides a user interface for expert users to input natural language descriptions of workflows. The conversational composite actions composer interface 150 works in conjunction with the control flow creation service 155 to convert these descriptions into executable workflows. It also allows expert users to review and modify generated workflows, adjusting input bindings and customizing the execution process.

When an end user interacts with the system 100 through the conversational planning interface 105, registered expert recipes are available to the user. The conversational planning interface 105 interface enables end users to interact with the system 100, submit queries, and execute workflows. It facilitates natural language input and guides users through the execution of selected recipes, collecting necessary parameters, and displaying results. The common AI service 110 searches through the available recipes in the composite action library 160 to pick the best matching recipe and then proceeds to execute the recipe in a sandboxed environment (e.g., a virtual data container, etc.). The system 100 identifies the input information required and fills required slots from the user to provide accurate and relevant information in response to the query while keeping the user authorization levels in mind.

The control flow creation service 155 is responsible for converting natural language descriptions into executable workflows. It works with the LLM services 120 to break down expert user instructions into a series of specific, parameterized steps. The service analyzes dependencies between steps, categorizing them as serial or parallel, and absolute or conditional. This analysis results in a conditional control flow that can be represented as a directed acyclic graph (DAG).

The orchestrator 145, also referred to as the execution engine, manages the execution of workflows. It takes a selected recipe and executes it in a stepwise manner. Each node in a DAG of a workflow is executed sequentially, with results stored in an ephemeral store accessible to all other nodes within the recipe. The orchestrator 145 interacts with the common AI service 110 to collect required parameters from users and initiate calls to appropriate atomic agents. It also provides visual or textual feedback to users during execution and offers the ability to pause and inspect outputs of specific steps.

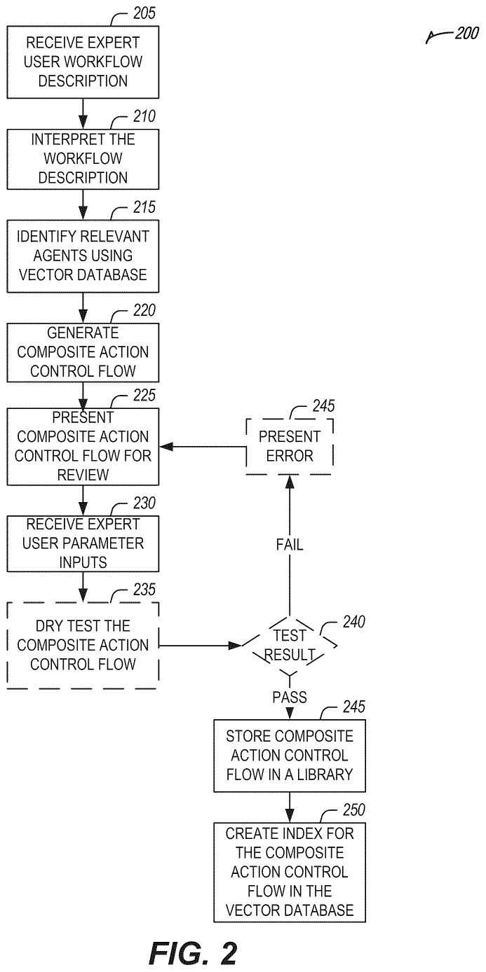

FIG. 2 is a flowchart for an example workflow creation process 200 for conversational composite action execution, according to an embodiment.

At operation 205, a natural language description of a workflow is received from an expert user through a user interface (e.g., the conversational composite actions composer interface 150 as described in FIG. 1, etc.).

At operation 210, a common AI service (e.g., the common AI service 110 as described in FIG. 1) utilizes Large Language Models (LLMs) of LLM services (e.g., the LLM service 120 as described in FIG. 1, etc.) to process the input to interpret the natural language description of the workflow.

At operation 215, a semantic search is performed through a vector database (e.g., the vector database 115 as described in FIG. 1, etc.) to identify relevant atomic agents from an agent library (e.g., the agent library 125 as described in FIG. 1, etc.) that match the described workflow steps.

At operation 220, a control flow creation service (e.g., the control flow creation service 155 as described in FIG. 1, etc.), in conjunction with the LLMs, generates a Directed Acyclic Graph (DAG) representing the workflow.

At operation 225, the generated control flow is presented to the expert user through the user interface for review and potential modifications.

At operation 230, the expert user may submit input binding adjustments for agents, choosing to hard-code inputs, bind them to outputs from upstream agents, or designate them to be provided by the end user at runtime and provides a description of the control workflow (e.g., recipe, etc.) purpose and functionality.

Dry run testing may be provided in the user interface. For example, at operation 235, a dry run mode may be presented to the expert user to enable a preview and test of the workflow without modifying actual data. It is determined at decision 240 whether the dry test was successful. If not, an error may be presented to the user interface at operation 245. If the dry run test is successful, the completed composite action control flow is embedded and stored in a composite action library (e.g., the composite action library 160 as described in FIG. 1, etc.). At operation 250, an index for the composite action control flow is created in the vector database.

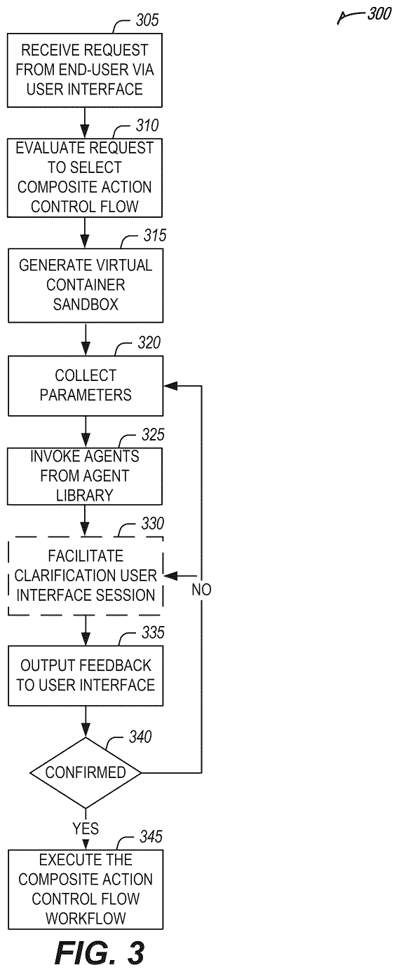

FIG. 3 is a flowchart of an example of recipe execution process 300 for conversational composite action execution, according to an embodiment.

At operation 305, a natural language request is received from interaction with a user interface (e.g., the conversational planning user interface 105 as described in FIG. 1, etc.) by an end user.

At operation 310, a common AI service (e.g., the common AI service 110 as described in FIG. 1, etc.) evaluates the natural language request using LLMs (e.g., of the LLM services 120 as described in FIG. 1, etc.) to identify (e.g., from the composite action library 160, etc.) an appropriate composite action control flow to execute (e.g., via the orchestrator 145 as described in FIG. 1, etc.).

At operation 315, a virtual container (e.g., a sandboxed environment, etc. is initialized for executing the selected composite action control flow. At operation 320, required input information is identified and necessary parameters are collected from the user. At operation 325, the orchestrator initiates calls to corresponding agents from the agent library (e.g., the agent library 125 as described in FIG. 1, etc.) for each step in the composite action control flow.

The user may be prompted for missing data or corrected data/In an example, if an agent requires further clarification, a ‘need\_dialog’ state may be entered and the common AI service may facilitate a conversation between the end user and the agent at operation 330.

At operation 335, agents provide visual or textual feedback to the user interface to inform the user of a status of the executing composite action control flow. At decision 340, it is determined whether the user has provided consent to proceed to the next step of the composite action control flow workflow. If not, the user may be prompted to change parameters (e.g., at operation 320), initiate a clarification session (e.g., at operation 330, etc.). etc. If it is determined that the user has provided consent at decision 340, the composite action control flow is systematically executed as prescribed by an expert user who created the composite action control flow (e.g., as indicated in the composite action library 160 as described in FIG. 1, etc.).

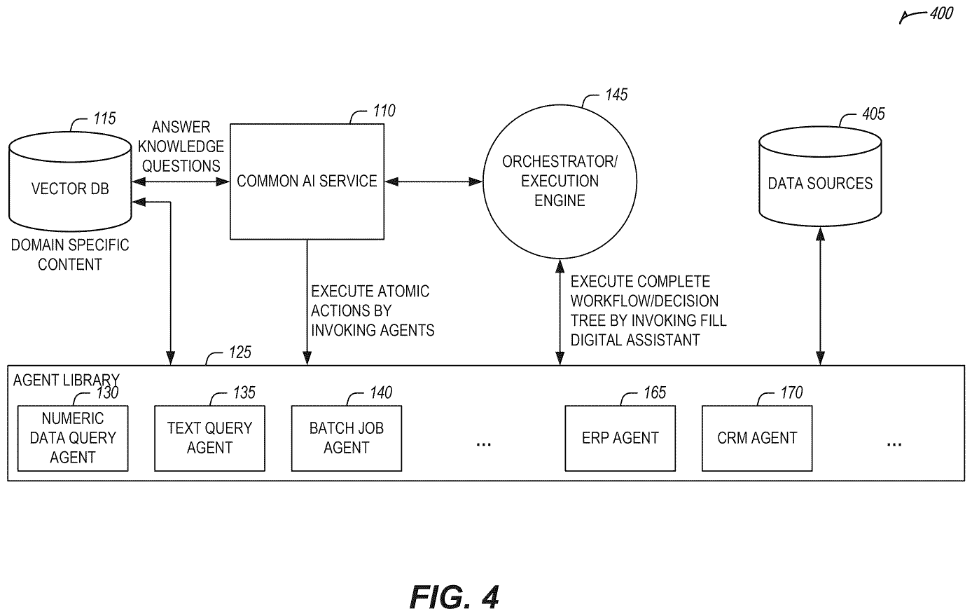

FIG. 4 illustrates an example agent interaction flow 400 for conversational composite action execution, according to an embodiment.

The common AI service 110 interacts with the orchestrator 145 to initiate execution of a composite action control flow. The orchestrator 145 queries the agent library 125 to identify and select appropriate agents for each step of the composite action control flow. The agent library 125 interacts with the vector database 115 to retrieve agent metadata and configurations. Selected agents from the agent library 125 interact with various data sources 405 to perform assigned tasks (e.g., querying numeric data, updating text, executing batch jobs, etc.). The agents report back to the orchestrator 145 with results of executed operations (or execution attempts of operations). The orchestrator 145 communicates with the common AI service 110 to provide execution feedback and to request user input when needed. The common AI service 110 may interact directly with specific agents if further clarification or user dialog is needed during execution.

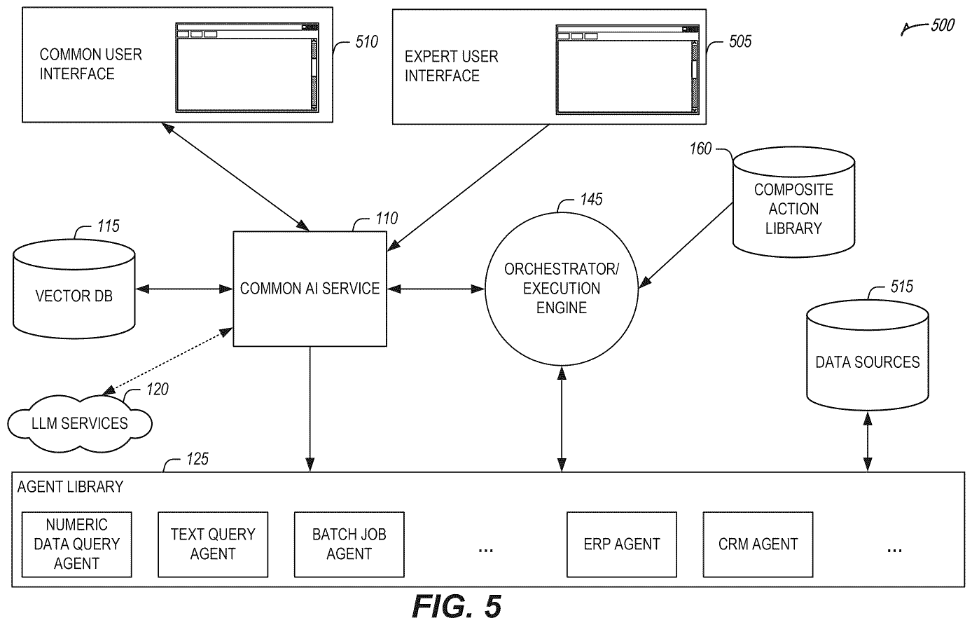

FIG. 5 illustrate an example data flow 500 for conversational composite action execution, according to an embodiment.

An expert user interface 505 (e.g., the conversational composite actions composer interface 150, etc.) sends natural language workflow descriptions to the common AI service 110. A common user interface 510 (e.g., the conversational planning user interface 105 as described in FIG. 1, etc.) sends user queries and requests to the common AI service 110. The common AI service 110 interacts bidirectionally with the LLM services 120 for natural language processing and workflow generation. The common AI service 110 queries the vector database 115 to search for relevant agents (e.g., from the agent library 125, etc.) and composite action control flows (e.g., from the composite action library 160, etc.). The vector database 115 provides embeddings and search results to the common AI service 110. The agent library 125 sends agent metadata to the vector database 115 for indexing.

The composite action library 160 stores and retrieves composite action control flows, interacting with the vector database 115 for efficient search. The common AI service 110 sends execution instructions to the orchestrator 145. The orchestrator 145 retrieves agents from the agent library 125 and composite action control flows from the composite action library 160. The agents from the agent library 125 interact with various data sources 515 to perform data operations. The orchestrator 145 sends execution results back to the common AI service 110 for user feedback via the common user interface 510.

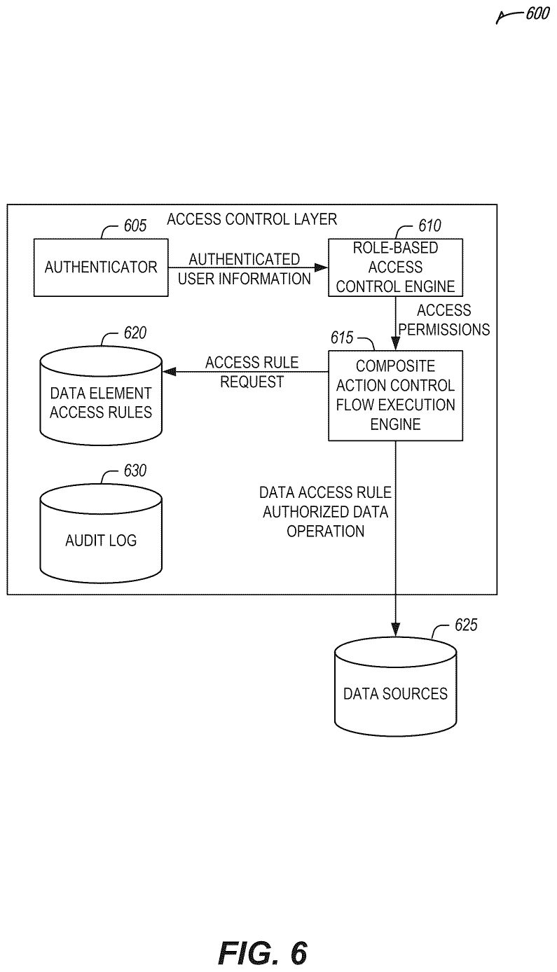

FIG. 6 is a block diagram of an example access control layer 600 for conversational composite action execution, according to an embodiment. The example access control layer 600 may be employed in the systems and processes described in FIGS. 1 to 5.

An authenticator 605 verifies user identity and retrieves user role information. A role-based access control (RBAC) engine 610 determines user permissions based on a role defined in credentials of the user. Data element access rules 620 define specific access rights for different data elements. A composite action control flow execution engine 615 attempts to execute steps of a composite action control flow. Data Sources 625 contain the actual data elements that may be accessed or modified. An audit log 630 records access attempts and actions for compliance and security purposes.

The authenticator 605 sends authenticated user information to the RBAC engine 610. The RBAC engine 610 provides access permissions to the Recipe Execution Engine (640). The composite action control flow execution engine 615 accesses the data element access rules 620 to verify data operation authorization before accessing or modifying data in the data sources 625. If access is denied, the composite action control flow execution engine 615 halts execution and rolls back or prevents application of changes in a virtual data container without impacting live data. Access attempts and actions are recorded in the audit log 630.

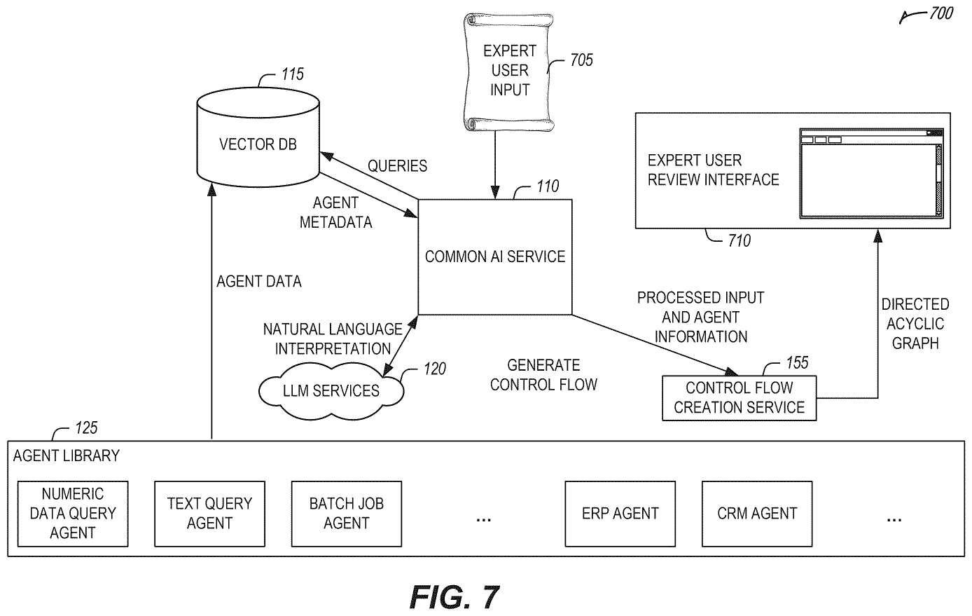

FIG. 7 illustrates an example of data flow 700 of a control flow creation service for conversational composite action execution, according to an embodiment.

Expert user input 705 provides a natural language description of a workflow to the common AI service 110. The common AI service 110 processes the input and interacts with the LLM services 120 for natural language interpretation. The common AI service 110 queries the vector database 115 to identify relevant agents from the agent library 125. The vector database 115 returns matching agent metadata to the common AI service (720). The common AI service 110 sends the processed input and relevant agent information to the control flow creation service 155. The control flow creation service 155 interacts with the LLM services 120 to generate a control flow. The control flow creation service 155 produces a generated Directed Acyclic Graph (DAG) representing the workflow for presentation to an expert user through an expert user review interface 710 for validation and potential modifications.

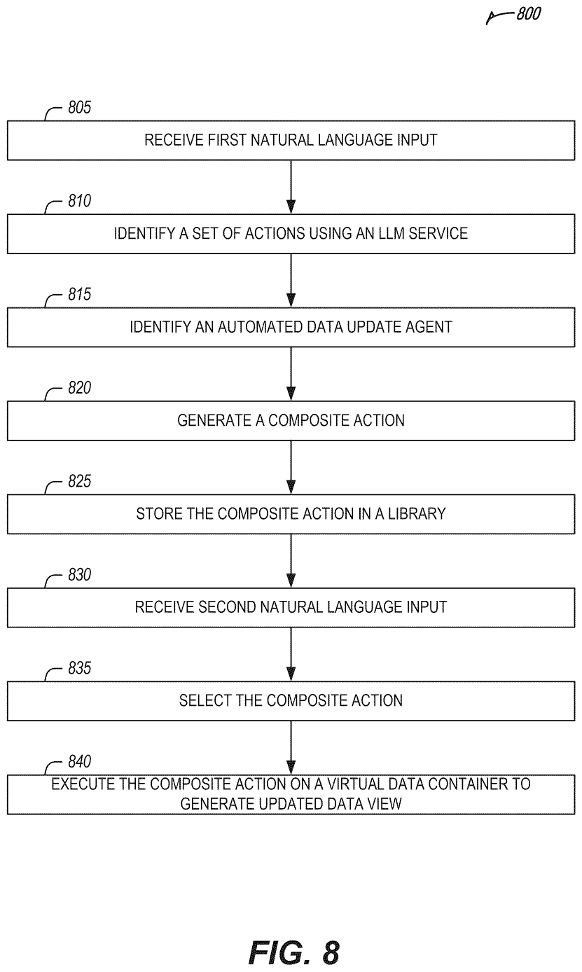

FIG. 8 illustrates an example of a method 800 for conversational composite action execution, according to an embodiment. The method 800 may provide features as described in FIGS. 1 to 7.

First natural language input is received that describes a workflow from a first user interface (e.g., at operation 805). The first natural language input is evaluated with a large language model to identify a set of actions to perform the workflow (e.g., at operation 810). An automated data update agent is identified to perform at least a portion of the workflow based on a match between the set of actions and metadata of the automated data update agent (e.g., at operation 815). A composite action is generated using a set of computing commands identified for the automated update agent using the set of actions (e.g., at operation 820). The composite action in a composite action database (e.g., at operation 825). Second natural language input is received from a second user interface (e.g., at operation 830). The composite action is selected from the composite action library by evaluating the second natural language input using an artificial intelligence processor and the large language model (e.g., at operation 835). The composite action is executed on a virtual data container to generate an updated data view in the second user interface (e.g., at operation 840).

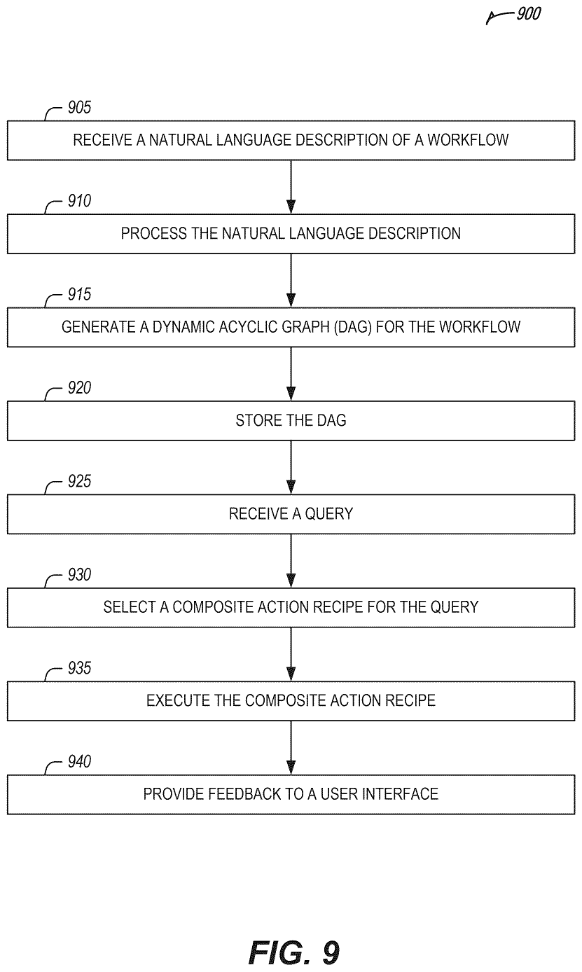

FIG. 9 is a flowchart of an example of a method 900 for generating and executing composite actions using natural language processing, according to an embodiment. The method 900 may provide features as described in FIGS. 1 to 7.

A natural language description of a workflow is received from an expert user interface (e.g., at operation 905). This description is then processed using a large language model to identify a sequence of actions for performing the workflow (e.g., at operation 910). Based on this analysis, a directed acyclic graph (DAG) is generated that represents the workflow by mapping the sequence of actions to a set of automated agents from an agent library (e.g., at operation 915).

The generated DAG is stored as a composite action recipe in a vector database (e.g., at operation 920). When an end user submits a natural language query through their interface (e.g., at operation 925), the composite action recipe is selected from the vector database based on a semantic match between the query and the stored recipe (e.g., at operation 930).

The selected composite action recipe is executed in a virtual data container (sandboxed environment)(e.g., at operation 935). This execution involves sequentially invoking the set of automated agents according to the DAG structure. Throughout the execution process, the system provides real-time feedback to the end user interface (e.g., at operation 940).

To enhance the workflow creation process, a graphical representation of the generated DAG is presented to the expert user interface for validation and modification. During the DAG generation, dependencies between actions of the sequence of actions are analyzed to determine parallel, serial, absolute, and conditional relationships between the actions.

The execution of the composite action recipe may involve dynamically collecting required parameters from the end user interface. To ensure data security, role-based access control may be applied to restrict access to data elements during execution based on end user permissions.

The set of automated agents used may include various specialized agents such as numeric data query agents, text query agents, batch job agents, enterprise resource planning (ERP) agents, and customer relationship management (CRM) agents.

For testing purposes, a dry run execution of the composite action recipe may be performed in response to a request from the expert user interface. This dry run simulates the workflow without modifying actual data, allowing for validation before real execution.

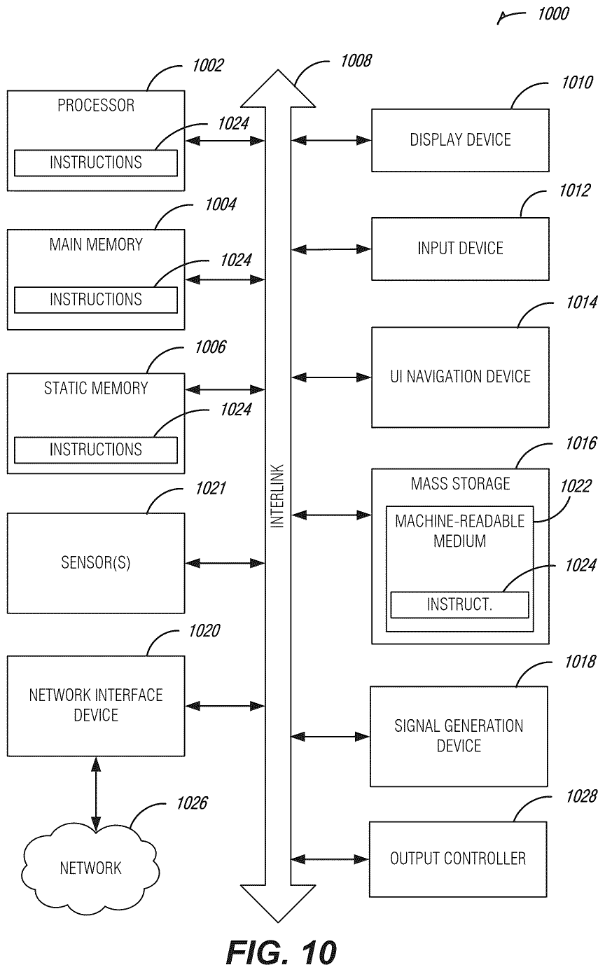

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensors. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### Additional Notes

1The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for generating and executing composite actions using natural language processing comprising:
at least one processor; and
memory comprising instructions that, when executed by the at least one processor, cause the at least one processor to perform operations to:
receive a natural language description of a workflow from an expert user interface;
process the natural language description using a large language model to identify a sequence of actions for performing the workflow;
generate a directed acyclic graph (DAG) representing the workflow by mapping the sequence of actions to a set of automated agents from an agent library;
store the DAG as a composite action recipe in a vector database;
receive a natural language query from an end user interface;
select the composite action recipe from the vector database based on a semantic match between the natural language query and the stored composite action recipe;
execute the composite action recipe in a virtual data container by sequentially invoking the set of automated agents according to the DAG; and
provide real-time feedback of the execution to the end user interface.

2. The system of claim 1, the memory further comprising instructions that, when executed by the at least one processor, cause the at least one processor to perform operations to:
present a graphical representation of the generated DAG to the expert user interface for validation and modification.

3. The system of claim 1, the instructions to generate the DAG further comprising instructions to:
analyze dependencies between the sequence of actions to determine parallel, serial, absolute, and conditional relationships between actions of the sequence of actions.

4. The system of claim 1, the instructions to execute the composite action recipe further comprising instructions to:
dynamically collect required parameters from the end user interface during execution of the composite action recipe.

5. The system of claim 1, the memory further comprising instructions that, when executed by the at least one processor, cause the at least one processor to perform operations to:
apply role-based access control to restrict access to data elements during execution of the composite action recipe based on end user permissions.

6. The system of claim 1, wherein the set of automated agents includes at least one of: a numeric data query agent, a text query agent, a batch job agent, an enterprise resource planning (ERP) agent, and a customer relationship management (CRM) agent.

7. The system of claim 1, the memory further comprising instructions that, when executed by the at least one processor, cause the at least one processor to perform operations to:
perform a dry run execution of the composite action recipe in response to a request from the expert user interface, wherein the dry run execution simulates the workflow without modifying actual data.

8. At least one non-transitory machine-readable medium comprising instructions for generating and executing composite actions using natural language processing that, when executed by at least one processor, cause the at least one processor to perform operations to:
receive a natural language description of a workflow from an expert user interface;
process the natural language description using a large language model to identify a sequence of actions for performing the workflow;
generate a directed acyclic graph (DAG) representing the workflow by mapping the sequence of actions to a set of automated agents from an agent library;
store the DAG as a composite action recipe in a vector database;
receive a natural language query from an end user interface;
select the composite action recipe from the vector database based on a semantic match between the natural language query and the stored composite action recipe;
execute the composite action recipe in a virtual data container by sequentially invoking the set of automated agents according to the DAG; and
provide real-time feedback of the execution to the end user interface.

9. The at least one non-transitory machine-readable medium of claim 8, further comprising instructions that, when executed by the at least one processor, cause the at least one processor to perform operations to:
present a graphical representation of the generated DAG to the expert user interface for validation and modification.

10. The at least one non-transitory machine-readable medium of claim 8, the instructions to generate the DAG further comprising instructions to:
analyze dependencies between the sequence of actions to determine parallel, serial, absolute, and conditional relationships between actions of the sequence of actions.

11. The at least one non-transitory machine-readable medium of claim 8, the instructions to execute the composite action recipe further comprising instructions to:
dynamically collect required parameters from the end user interface during execution of the composite action recipe.

12. The at least one non-transitory machine-readable medium of claim 8, further comprising instructions that, when executed by the at least one processor, cause the at least one processor to perform operations to:
apply role-based access control to restrict access to data elements during execution of the composite action recipe based on end user permissions.

13. The at least one non-transitory machine-readable medium of claim 8, wherein the set of automated agents includes at least one of: a numeric data query agent, a text query agent, a batch job agent, an enterprise resource planning (ERP) agent, and a customer relationship management (CRM) agent.

14. The at least one non-transitory machine-readable medium of claim 8, further comprising instructions that, when executed by the at least one processor, cause the at least one processor to perform operations to:
perform a dry run execution of the composite action recipe in response to a request from the expert user interface, wherein the dry run execution simulates the workflow without modifying actual data.

15. A computer-implemented method for generating and executing composite actions using natural language processing, comprising:
receiving, by a processor, a natural language description of a workflow from an expert user interface;
processing, by the processor, the natural language description using a large language model to identify a sequence of actions for performing the workflow;
generating, by the processor, a directed acyclic graph (DAG) representing the workflow by mapping the sequence of actions to a set of automated agents from an agent library;
storing the DAG as a composite action recipe in a vector database;
receiving, by the processor, a natural language query from an end user interface;
selecting, by the processor, the composite action recipe from the vector database based on a semantic match between the natural language query and the stored composite action recipe;
executing, by the processor, the composite action recipe in a virtual data container by sequentially invoking the set of automated agents according to the DAG; and
providing, by the processor, real-time feedback of the execution to the end user interface.

16. The method of claim 15, further comprising:
presenting, by the processor, a graphical representation of the generated DAG to the expert user interface for validation and modification.

17. The method of claim 15, wherein generating the DAG further comprises:
analyzing, by the processor, dependencies between the sequence of actions to determine parallel, serial, absolute, and conditional relationships between actions of the sequence of actions.

18. The method of claim 15, wherein executing the composite action recipe further comprises:
dynamically collecting, by the processor, required parameters from the end user interface during execution of the composite action recipe.

19. The method of claim 15, further comprising:
applying, by the processor, role-based access control to restrict access to data elements during execution of the composite action recipe based on end user permissions.

20. The method of claim 15, wherein the set of automated agents includes at least one of: a numeric data query agent, a text query agent, a batch job agent, an enterprise resource planning (ERP) agent, and a customer relationship management (CRM) agent.
